(19) United States
(12) Patent Application Publication
(10) Pub. No.: US 2025/0323950 A1
(43) Pub. Date: Oct. 16, 2025

(54) EXPLICIT PROXY SOLUTIONS FOR 5G SECURITY WITH SERVICE ACCESS SERVICE EDGE (SASE) WITH SERVICE PROVIDE NETWORK ATTACH TO PRISMA SASE

(71) Applicant: Palo Alto Networks, Inc., Santa Clara, CA (US)

(72) Inventors: Raghavaiah Avula, San Jose, CA (US); Arivu Mani Ramasamy, San Jose, CA (US); Subramanya Yashwanth Bommakanti, Newark, CA (US); Ketul Sheth, San Jose, CA (US)

(21) Appl. No.: 18/926,165

(22) Filed: Oct. 24, 2024

Related U.S. Application Data
(60) Provisional application No. 63/634,210, filed on Apr. 15, 2024.
(60) Provisional application No. 63/634,219, filed on Apr. 15, 2024.
(60) Provisional application No. 63/661,476, filed on Jun. 18, 2024.

(51) Int. Cl. H04L 9/40

(52) U.S. Cl. CPC H04L 63/20; H04L 63/0263; H04L 63/145

(57) ABSTRACT

Techniques for providing explicit proxy solutions for 5G Service Access Service Edge (SASE) with service provider network attach are disclosed. In some embodiments, a system, a process, and/or a computer program product for providing explicit proxy solutions for 5G SASE with service provider network attach includes receiving data plane traffic associated with a User Equipment (UE) from a mobile core network at a Secure Access Service Edge (SASE) cloud network via a service provider network attach using an interconnect between the mobile core network and the SASE cloud network; enforcing a security policy on data plane traffic associated with the UE based on contextual information associated with the UE to provide secured data plane traffic using the security policy configured per user group and/or per user; and forwarding the secured data plane traffic from the SASE cloud network to its original destination if allowed by the security policy, and blocking or dropping the data plane traffic from the SASE cloud network if not allowed by the security policy.

### CROSS REFERENCE TO OTHER APPLICATIONS

This application claims priority to U.S. Provisional Patent Application No. 63/634,210 entitled SECURE ACCESS SERVICE EDGE FOR MOBILE NETWORKS filed Apr. 15, 2024, U.S. Provisional Patent Application No. 63/634,219 entitled SECURE ACCESS SERVICE EDGE FOR MOBILE NETWORKS filed Apr. 15, 2024, and U.S. Provisional Patent Application No. 63/661,476 entitled SECURE ACCESS SERVICE EDGE SOLUTION FOR PROVIDING ENHANCED SECURITY FOR MOBILE NETWORKS filed Jun. 18, 2024, all of which are incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 is a system diagram of an architecture for providing explicit proxy solutions for 5G SASE with service provider network attach in accordance with some embodiments.

FIG. 2 is a flow diagram of a process for providing explicit proxy solutions for 5G SASE with service provider network attach in accordance with some embodiments.

FIG. 3 is another flow diagram of a process for providing explicit proxy solutions for 5G SASE with service provider network attach in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls, which can also be implemented using SD-WAN devices).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

Security service providers also offer various commercially available cloud-based security solutions including various firewall, VPN, including Secure Access Service Edge (SASE), and various other security related services. For example, some security service providers have their own data centers in multiple geographies across the world to provide their customers such cloud-based security solutions.

Generally, a secure access service edge (SASE) brings together networking and network security services in a single cloud-based platform. This way, organizations can embrace cloud and mobility while reducing the complexity of dealing with multiple point products as well as saving IT, financial, and human resources.

For example, a SASE solution can generally include networking capabilities that an enterprise already uses. SASE can integrate the following networking features into a cloud-based infrastructure: SD-WAN edge devices, VPN services, and web proxying, which are each further described below.

Software-defined wide area network (SD-WAN) edge devices can provide easier connectivity for branch offices. With SASE, these devices are connected to a cloud-based infrastructure rather than to physical SD-WAN hubs located in other locations. By moving to the cloud, enterprises can eliminate the complexity of managing physical SD-WAN hubs and promote interconnectivity between branch offices.

Virtual private network (VPN) services incorporated by a SASE solution enable enterprises to route traffic through a VPN (e.g., using IPSec tunnels) to the SASE solution, and then to any application in the public or private cloud, delivered via Software as a Service (Saas), or on the Internet. Traditional VPN was used for remote access to the internal data center, but it is typically not optimized for the current/evolving cloud computing environment.

Web proxying provides an alternate means of securely connecting users to applications by inspecting web-based protocols and traffic. Proxies were typically used for web security enforcement, but due to their inherent security limitations, they are now typically used as an architectural alternative for device traffic that cannot be fully inspected (e.g., personal devices that cannot accept an endpoint agent to force all web and non-web traffic through security inspection). When implemented as part of a SASE solution, proxies can offer organizations with legacy architectures an easier way of adopting the more robust security capabilities SASE has to offer.

In addition, SASE can incorporate the network security service tools enterprises have generally relied upon in prior computing environments. In a comprehensive SASE solution, the following security services can be delivered through a cloud-based infrastructure: Zero Trust Network Access (ZTNA), firewall/security as a service (FWaaS), secure web gateways (SWG), data loss prevention (DLP), and cloud access security broker (CASB), which are each further described below.

Zero Trust Network Access (ZTNA) applies the Zero Trust secure computing approach (e.g., never trust, always verify) to the cloud computing environment. For example, ZTNA can be applied to require that every user authenticate to access the cloud, restricting access and minimizing the risk of, for example, data loss. However, ZTNA solutions based on a software-defined perimeter (SDP) model can lack content inspection capabilities needed for consistent security protection for enterprises. Also, moving to a cloud-based SASE infrastructure can eliminate the complexity of connecting to a gateway. For example, users, devices, and apps can be identified no matter where they connect from, and the below further described ZTNA solutions of protecting applications can be applied across all services, including data loss prevention (DLP) and threat prevention.

Firewall as a service (FWaaS) provides next-generation firewall features in the cloud computing environment (e.g., also referred to herein as the cloud), thereby removing the need for physical hardware at branch and retail locations. For example, SASE solutions can integrate FWaaS into its cloud-based platform, allowing simplified management and deployment.

### Overview of Techniques for Explicit Proxy Solutions for 5G Sase With Service Provider Network Attach

Technical and security challenges with providing security for service provider networks exist. Specifically, technical and security challenges with integration of mobile devices connecting via mobile networks (e.g., 4G, 5G, 6G, and later mobile devices) with Secure Access Service Edge (SASE) solutions exist.

Secure Access Service Edge (SASE) generally refers to providing converged network and security as a service capabilities, including Software Defined Wide Area Networking (SD-WAN), Secure Web Gateway (SWG), Cloud Access Security Broker (CASB), firewall as a service (e.g., using a Network Gateway Firewall (NGFW), which can be implemented using a VM-based or container-based firewall, such is in a cloud-based computing environment), and Zero Trust Network Access (ZTNA).

More specifically, there exists a need for improved integration for mobile networks with SASE solutions as a Service, which can address the security and technical challenges, such as will now be described below.

For example, enterprise users of mobile networks (e.g., 5G or later generation mobile networks) face several security challenges and potential risks that need to be addressed. We will now discuss some of the existing security problems related to 5G enterprise users.

Secure Remote Access: With the increased mobility and remote workforce enabled by 5G and later generation mobile networks, enterprises are increasingly confronted with the ever increasing security and technical challenges to ensure secure remote access to corporate resources and applications for their employees and authorized users. This includes implementing robust authentication, authorization, and encryption mechanisms to protect against unauthorized access and data breaches.

Cloud and Edge Computing Security: 5G networks significantly rely on cloud and edge computing architectures, which introduce new security risks for enterprises. Ensuring the security of data and applications hosted in the cloud or at the edge, as well as the secure communication between these components and the enterprise network, is crucial.

Internet of Things (IoT) and Industrial IoT (IIoT) Security: 5G networks are expected to enable a massive number of connected IoT and IIoT devices for enterprises. Securing these IoT/IIoT devices, their communications, and the data they generate is a significant challenge, as many IoT/IIoT devices have limited security capabilities and can be potential entry points for cyber threats.

Network Slicing and Virtualization Security: 5G and later generation mobile networks leverage network slicing and virtualization technologies to provide customized and isolated network services. As such, enterprises are increasingly confronted with the ever increasing security and technical challenges to ensure the secure configuration and isolation of their network slices, as well as the security of the underlying virtualization platforms and virtual network functions (VNFs).

Supply Chain Security: Enterprises also are confronted with potential security risks in the global supply chain of 5G or later generation mobile network components and devices. For example, compromised hardware or software from untrusted sources can introduce vulnerabilities or backdoors into the enterprise network.

Compliance and Regulatory Requirements: Enterprises operating in regulated industries, such as finance, healthcare, or government, often are required to ensure that their 5G or later generation mobile network deployments and data handling practices comply with relevant security and privacy regulations, such as GDPR, HIPAA, or industry-specific standards.

Secure Software Updates and Patch Management: With the increased complexity and software-defined nature of 5G and later generation mobile networks, enterprises should also focus on having robust processes for secure software updates and patch management to address vulnerabilities and security flaws in a timely manner.

Security Monitoring and Incident Response: Enterprises generally have various technical and security challenges with implementing effective security monitoring and incident response mechanisms to detect and respond to potential security incidents or breaches in their 5G or later generation mobile networks and connected systems.

Thus, what are needed are new and improved solutions for monitoring such network traffic and applying intelligent security for zero trust in mobile network environments using a SASE solution, such as for mobile devices (e.g., UEs) communicating over service provider networks (e.g., mobile networks associated with one or more service providers, such as AT&T, T-Mobile, Verizon, etc.).

Accordingly, new and improved techniques for providing explicit proxy solutions for 5G Service Access Service Edge (SASE) with service provider network attach are disclosed. The disclosed techniques for providing explicit proxy solutions for 5G SASE with service provider network attach can effectively address these security and technical challenges as will be further described below.

Accordingly, the disclosed techniques for providing SASE for mobile networks to facilitate a system/process/computer program product for applying intelligent security for zero trust using a Service Access Service Edge (SASE) solution will now be further described below.

For example, the disclosed techniques for providing SASE for mobile networks includes monitoring network traffic and applying intelligent security for zero trust for devices communicating via mobile network environments using a SASE solution, such as for mobile devices (e.g., UEs) connecting to and/or communicating over service provider networks (e.g., mobile networks associated with one or more service providers, such as AT&T, T-Mobile, Verizon, etc.) for applying context-based and/or enhanced security in mobile networks based on subscriber-ID/International Mobile Subscriber Identity (IMSI)/Subscription Permanent Identifier (SUPI), equipment-ID/International Mobile Equipment Identity (IMEI)/Permanent Equipment Identifier (PEI), Network Slice ID/Single Network Slice Selection Assistance Information (S-NSSAI), User Equipment (UE) IP, Access Point Name (APN)/Data Network Name (DNN), and/or Radio Access Technology (RAT) Type information, IP to mobile subscriber traffic mappings, and/or other context-based information to facilitate enhanced security for such mobile devices communicating via mobile networks to access enterprise networks, applications including Software as a Service (SaaS)-based applications or other cloud based applications/services, and/or other Internet activities, such as will be further described below.

The disclosed techniques for providing SASE for mobile networks provides for a seamless integration with such service provider's mobile networks without requiring security equipment or software to be located in the service provider's core mobile networks, such as will be further described below.

In some embodiments, a system, a process, and/or a computer program product for providing explicit proxy solutions for 5G SASE with service provider network attach includes receiving data plane traffic associated with a User Equipment (UE) from a mobile core network at a Secure Access Service Edge (SASE) cloud network via a service provider network attach using an interconnect between the mobile core network and the SASE cloud network; enforcing a security policy on data plane traffic associated with the UE based on contextual information associated with the UE to provide secured data plane traffic using the security policy configured per user group and/or per user; and forwarding the secured data plane traffic from the SASE cloud network to its original destination if allowed by the security policy, and blocking or dropping the data plane traffic from the SASE cloud network if not allowed by the security policy.

For example, the SASE cloud network can include a firewall as a service (FWaaS) that is configured with a plurality of security policies based on a subscriber identity, a unique device identifier, and an application identifier, wherein the subscriber identity includes an International Mobile Subscriber Identity (IMSI), and wherein the unique device identifier includes an International Mobile Equipment Identifier (IMEI). The mobile core network can include a 4G mobile core network, a 5G mobile core network, and/or 6G mobile core network (e.g., or later generation mobile core network). The data plane traffic is secured from and to 4G, 5G, and/or 6G UE devices. The Internet access is secured from and to 4G, 5G, and/or 6G UE devices. The enterprise data center access (e.g., for a tenant of the SASE solution) is secured from and to 4G, 5G, and/or 6G UE devices. The selection and the enforcement of the security policy is based on the contextual information associated with the UE and the data plane traffic correlated with the UE based on a UE Internet Protocol (IP) address.

Various security use cases can be addressed using the disclosed techniques for providing explicit proxy solutions for 5G SASE with service provider network attach including one or more of the following: (1) a firewall as a service (FWaaS) associated with the SASE is configured to perform Uniform Resource Link (URL) filtering for the data plane traffic; (2) a firewall as a service (FWaaS) associated with the SASE is configured to perform application Denial of Service (DoS) detection for the data plane traffic; and (3) a firewall as a service (FWaaS) associated with the SASE is configured to perform application Denial of Service (DoS) prevention for the data plane traffic.

In an example implementation, each of a plurality of security policies is distinctly selected and enforced for each mobile service provider (MSP) enterprise tenant at the SASE cloud network, wherein per tenant security policy configuration and enforcement are provided by the SASE cloud network.

In an example implementation, the data plane traffic is encapsulated with meta information, including a subscriber identity and/or a unique device identifier.

In some embodiments, a system, a process, and/or a computer program product for providing explicit proxy solutions for 5G SASE with service provider network attach further includes determining the security policy to apply at the SASE cloud network to the data plane traffic based on a subscriber identity and/or a unique device identifier.

In some embodiments, a system, a process, and/or a computer program product for providing explicit proxy solutions for 5G SASE with service provider network attach includes receiving mobile network service provider configuration settings for a plurality of mobile network attributes for a mobile core network in a portal for a Secure Access Service Edge (SASE) cloud network; receiving a security policy configured per user group and/or per user for a tenant for the SASE cloud network; activating an interconnect between the mobile core network and the SASE cloud network; routing data plane traffic from the mobile core network and a RADIUS message to a load balancing endpoint for the SASE cloud network; processing a RADIUS start message and populating synchronization data with a mobile user identity and IP mapping for the SASE cloud network; processing the data plane traffic using a security processing node (SPN) in the SASE cloud network and applying the configured security policy for the tenant; and performing an action on the data plane traffic based on a verdict after applying the configured security policy for the tenant.

Specifically, SASE (e.g., using a firewall as a service entity) can be configured to process mobile network traffic received over the interconnect from the core mobile network (e.g., independent of any particular mobile core network protocols; as control plane signaling can be provided, for example, via RADIUS, Diameter, or SP API gateway services, such as further described herein) to extract contextual information, which can include User Equipment (UE) IP, IMSI/SUPI (e.g., Subscriber-ID), IMEI/PEI, S-NSSAI, APN/DNN, S-NSSAI, RAT Type information, IP to mobile subscriber traffic mappings, and/or other context-based information. The security platform is further configured to apply a security policy (e.g., enforce one or more security rules) based on the contextual information.

The disclosed techniques for providing SASE for mobile networks facilitate a cloud native SASE stack and interconnect with a core mobile network (e.g., a 4G/5G/6G/later mobile network core environment).

Also, the disclosed techniques for providing SASE for mobile networks facilitate an agentless solution (e.g., an agent is not required to be deployed on the 5G mobile device). An agent for roaming devices and non-cellular/non-SIM devices can be provided using various techniques, such as will be further described below.

In addition, the disclosed techniques for providing SASE for mobile networks facilitate context-based security for mobile devices/users without requiring additional security equipment or security software/entities within the core mobile network (e.g., 5G packet core network).

As such, the disclosed techniques for providing SASE for mobile networks facilitate a SASE-based solution for mobile network environments (e.g., macro 5G, private 5G, and/or hybrid environments) with consistent zero trust policies (e.g., based on IMSI/IMEI and/or other context information).

Further, the disclosed techniques for providing SASE for mobile networks facilitate a comprehensive multi-tenancy solution that can manage all 5G enterprise networks (e.g., with a single pane of glass).

Moreover, the disclosed techniques for providing SASE for mobile networks facilitate a global solution across all geo-locations worldwide and provide auto-scalability based on traffic volumes and customer growth by providing a seamless mobile core network interconnect integration with a hyperscaler SASE solution.

As an example use case, a cellular (e.g., 4G/5G/6G/later cellular network standards) mobile network service provider can utilize the disclosed techniques for providing SASE for their 5G network customers to offer enhanced security services as a managed service, such as to their enterprise customers that have 5G enterprise deployments and/or to their individual subscribers, such as for additional subscription fees for such enhanced security services.

As another example use case, a cellular (e.g., 4G/5G/6G/later cellular network standards) mobile network service provider can utilize the disclosed techniques for providing SASE for their own internal enterprise users for enhanced security services to protect/safeguard their internal enterprise users on their mobile network activities.

For example, the disclosed techniques for providing SASE for mobile networks can facilitate applying intelligent security for zero trust for mobile networks (e.g., based on an extracted Subscriber-ID and/or other contextual information) using a SASE environment in communication with a core mobile network via the cloud-to-cloud interconnect, such as further described below.

As yet another example, the disclosed techniques for providing SASE for mobile networks can facilitate applying intelligent security for zero trust for mobile networks including providing 5G subscriber/user and/or 5G equipment/device level known and unknown threat identification and prevention for 5G mobile network environments.

As yet a further example, the disclosed techniques for providing SASE for mobile networks can facilitate applying intelligent security for zero trust for mobile networks including providing 5G subscriber/user and/or 5G equipment/device level application security for 5G mobile network environments.

As a final example, the disclosed techniques for providing SASE for mobile networks can facilitate applying intelligent security for zero trust for mobile networks providing 5G subscriber/user and/or 5G equipment/device level URL filtering for 5G mobile network environments.

Moreover, service providers and enterprises can utilize the disclosed techniques applying security for zero trust in mobile networks using a SASE solution to apply subscriber-ID based security over IP-based external network (e.g., similar to the Internet) perimeters.

Accordingly, new and improved security solutions that facilitate applying security (e.g., network-based security) for zero trust in a 5G Service Access Service Edge (SASE) environment (e.g., the security platform can be implemented using a firewall (FW)/Next Generation Firewall (NGFW), a network sensor acting on behalf of the firewall, or another (virtual) device/component that can implement security policies using the disclosed techniques, including, for example, Palo Alto Networks' Prisma Access Secure Service Edge (SSE), Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) (e.g., a 5G/later versions of mobile networks), and in some cases, on various interfaces (e.g., N6, etc.) and protocols (e.g., PFCP, RADIUS, Diameter, etc.) in mobile network environments are disclosed in accordance with some embodiments.

As such, new and improved techniques for providing explicit proxy solutions for 5G Service Access Service Edge (SASE) with service provider network attach will now be further described below.

### Example System Architectures for Providing Explicit Proxy Solutions for 5G Sase With Service Provider Network Attach

Accordingly, in some embodiments, the disclosed techniques for SASE for mobile networks (e.g., such as for applying intelligent security for zero trust in mobile networks) can be provided using security platforms (e.g., the security function(s)/platform(s) can be implemented using Palo Alto Networks' Prisma Access Secure Service Edge (SSE), a firewall (FW)/Next Generation Firewall (NGFW), a network sensor acting on behalf of the firewall, or another (virtual) device/component that can implement a firewall as a service entity for enforcing one or more security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques, including using SD-WAN devices and/or clusters executing firewall as a service entities) are configured to provide deep packet inspection (DPI) capabilities (e.g., including stateful inspection) of, for example, user/subscriber sessions (e.g., user/subscriber traffic) provided to the SASE solution via an interconnect (e.g., a cloud-to-cloud interconnect, such as from a Google Cloud Platform (GCP) cloud-based environment for the service provider's core mobile network in to a SASE cloud-based environment) to apply security on traffic in mobile networks based on a policy (e.g., layer-7 security and/or other security policy enforcement) as further described below.

Specifically, as will now be described with respect to various system embodiments, context-based security can be applied to mobile device related traffic (e.g., 4G/5G/6G/later related mobile network traffic) using a SASE solution, such as will be further described below with respect to various embodiments. In an example implementation, context-based security can be applied using SASE to such traffic passing thru mobile networks based on one or more of the following: a subscriber/user including IMSI, IMEI, RAT type, Network Slice, DNN/APN, location, user IP, and/or other contextual information.

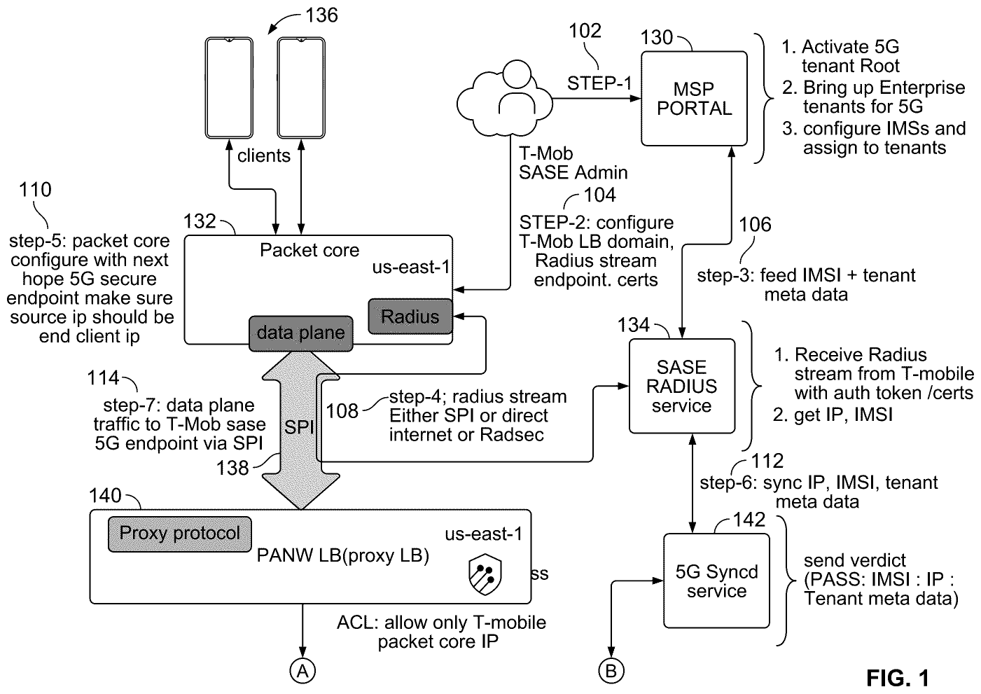

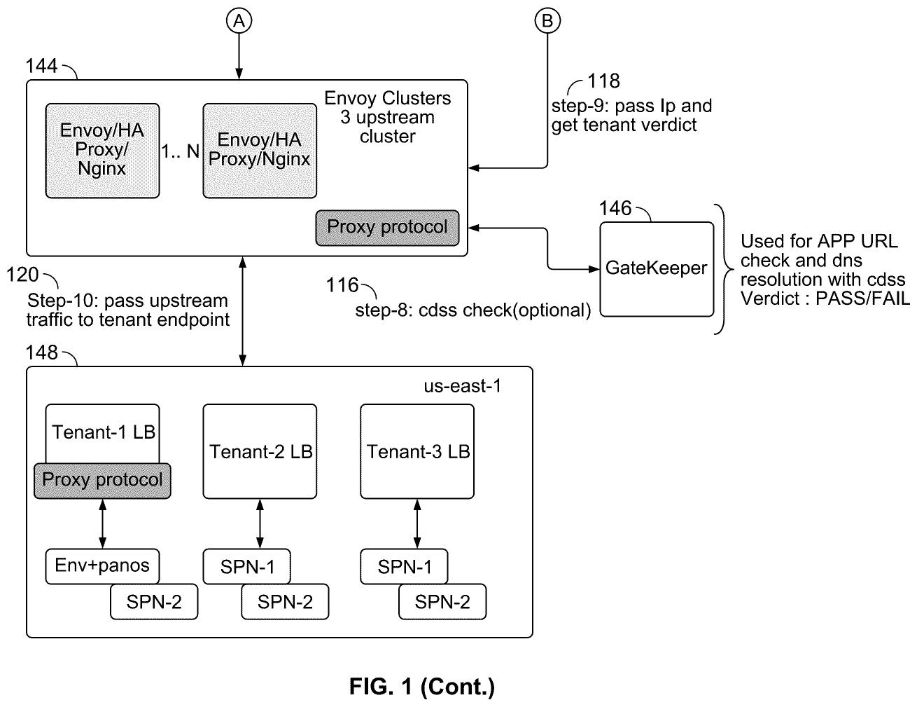

FIG. 1 is a system diagram of an architecture for providing explicit proxy solutions for 5G SASE with service provider network attach in accordance with some embodiments.

Specifically, FIG. 1 illustrates an example system embodiment for providing 5G Secure Access Service Edge (SASE) and endpoint (EP) network architecture. SASE generally refers to a cloud-based architecture that combines network and security functions into a single service. SASE delivers these services directly to the source of connection, rather than through a data center. Various commercially available SASE solutions are provided by security vendors, including, for example, Palo Alto Networks, Inc., headquartered in Santa Clara, CA.

More specifically, the disclosed techniques provide effective solutions for the above-described security and technical challenges with the SASE service providing 5G mobile network (or later generation mobile networks) seamless attach to the SASE service for security and address these various security and technical challenges for enterprise 5G/mobile network users. The disclosed techniques as will be further described below utilize the SASE access explicit proxy solution and service interconnection solution to provide seamless security for 5G/mobile network data traffic.

Specifically, FIG. 1 illustrates an example architecture for interconnecting a 5G mobile network cloud-based environment (e.g., including 5G Cloud Native Network Functions (CNFs)) with a SASE cloud-based environment, such as shown at 148 (e.g., which can be provided using a Prisma SASE hyperscaler cloud-based solution in this example, which is a commercially available SASE solution from Palo Alto Networks, Inc., headquartered in Santa Clara, CA, and/or other available SASE solution can similarly be used) using a cloud-to-cloud interconnect. In an example implementation, a Google Cloud Platform (GCP) Partner interconnect, such as shown as Service Provider Interconnect (SPI) 138, can be used to connect the 5G mobile network cloud, such as shown as mobile network packet core 132, with the Prisma SASE cloud (e.g., including a proxy layer 140, a cluster layer 142, and example SASE cloud-based environment 148) (e.g., or for other available cloud-based computing environments, such as Amazon Web Services (AWS), Microsoft Azure, etc., and other cloud-based interconnects provided for those cloud-based computing environments can similarly be used). Specifically, the GCP Partner Interconnect connection (e.g., as shown at 138 in FIG. 1) can be used for securely passing traffic between these cloud-based network environments 132 and 148.

Referring to SASE cloud 148, 5G Security Processing Nodes (SPN) clusters as shown in FIG. 1 provide firewall entities, specifically, firewalls as a service, for implementing the disclosed enhanced, context-based security for mobile devices connecting to the core 5G network shown at 132 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques via these firewall as a service entities) as further described below.

As referred to herein, IMSI is the concept referred to by ITU-T as the “International Mobile Subscription Identity.” IMSI is a 14 or 15 digit number.

As also referred to herein, SUPI is a globally unique 5G “Subscription Permanent Identifier” allocated to each subscriber in the 5G system. As per 3GPP T.S 23.003 version 16.9.0, a SUPI type may indicate an IMSI, a network access identifier (NAI), a Global Line Identifier (GLI), or a Global Cable Identifier (GCI).

As also referred to herein, International Mobile Equipment Identifier (IMEI) is defined in 3GPP TS 23.003 available at https://portal.3gpp.org/desktopmodules/Specifications/SpecificationDetails.aspx?specificationId=729.

Referring to FIG. 1, below are example stages of processing for providing explicit proxy solutions for 5G SASE with service provider network attach in this example implementation. In this example environment, clients (e.g., UEs) 136 are shown in communication with a mobile service provider's mobile packet core network 132.

At stage 102, a mobile service provider (e.g., a SASE admin, such as a T-Mobile SASE admin for a T-Mobile 5G network) configures IMSI, IMEI, APN, and/or other parameters associated with 5G mobile network traffic in the SASE provided Managed Service Provider (MSP) portal 130 (e.g., using the SCM portal in the Prisma Access SASE solution, which provides a platform to configure IMSI, IMEI, APN, etc. to identify UEs from each mobile service provider) under a managed service provider and configures respective security policies per user group/individual users. As shown, the 5G tenant root is activated. The enterprise tenants for 5G are instantiated, such as shown at 148. Also, the IMSI, IMEI, APN, and/or other mobile identifier related values are configured as described above and assigned to respective tenants.

At stage 104, the mobile service provider activates a partner interconnect/direct connect with the SASE cloud-based environment. For example, an interconnect can be activated to the SASE solution (e.g., using a cloud-to-cloud interconnect, such as from a Google Cloud Platform (GCP) cloud-based environment for the service provider's core mobile network into a SASE cloud-based environment, or another similar interconnect solution can similarly be provided) to apply security on traffic in mobile networks based on a policy (e.g., layer-7 security and/or other security policy enforcement) as further described below. Further, the interconnect can be configured with dedicated bandwidth on each packet core edge location to facilitate efficient network performance. As also shown at stage 104, the load balancer (LB) domain mobile service provider (e.g., T-Mobile in this example) and the RADIUS stream endpoint and certificates (certs) are configured.

At stage 106, an IMSI feed and tenant meta data are received at a SASE RADIUS service 134. In this example implementation, a RADIUS stream from the mobile service provider (e.g., T-Mobile in this example) with authentication (auth) tokens/certifications (certs) is received at the SASE RADIUS service. The SASE RADIUS service then extracts the associated IP address and IMSI from the RADIUS stream. As such, the SASE RADIUS service facilitates receiving and adding a mapping identifier to the IP mapping, such as further described below.

At stage 108, leveraging partner/direction to the SASE cloud, all the data path traffic and RADIUS messages are routed to the SASE service provider's endpoint using the service provider interconnect (SPI) (138) (e.g., or directly via the Internet or via the RadSec protocol over TCP or TLS protocols). In this example implementation, the RADIUS stream is routed to the SASE service provider's endpoint, shown as proxy load balancer (LB) (e.g., a Palo Alto Networks 140 (PANW) LB) via a proxy protocol.

At stage 110, the mobile service provider's packet core 132 is configured with the next hop 5G secure endpoint to ensure that the source IP address should be the end client IP address. For example, the mobile service provider network router can be configured with the next hop as the IP address for the SASE provider's Proxy Load Balancer (LB) (e.g., at stage 140) with NATTED UE client IP address. When the Proxy LB receives traffic at stage 140 and forwards the traffic to stage 144, the Envoy nodes can extract the source IP address as the actual mobile user client IP address and the destination as the actual destination IP address (e.g., similar to if the UE user attempted to reach a website, such as example.com, etc.).

At stage 112, the SASE service processes the RADIUS start message and populates the 5G sync data with 5G user identity (e.g., IMSI information), IP mappings, and tenant meta data in SASE edge devices in the SASE cloud-based network environment using a 5G synced service 142.

At stage 114, data plane traffic is sent from the mobile service provider packet core (138) to the SASE 5G endpoint (140) via the SPI (138). In this example implementation, the SASE 5G endpoint (140) is provided using a proxy load balancer (LB) (e.g., PANW LB) as shown in FIG. 1. The data plane traffic is then sent from the SASE 5G endpoint 140 to the cluster layer shown at 144 (e.g., a group of logically similar upstream hosts that Envoy connects to can be provided for the high-availability proxying layer to the SASE cloud-based environment shown at 148, which is a commercially available solution with publicly available documentation at https://www.envoyproxy.io/docs/envoy/latest/api-v3/config/cluster/v3/cluster.proto, or another commercially available clustering layer solution can be similarly provided). As such, the proxy layer facilitates receiving an allow IP list mapping to the tenant identifier and forwarding the traffic to the SASE cloud-based environment (148).

At stage 116, a cloud-delivered security services (CDSS) check is optionally performed. In this example implementation, a Gatekeeper 146 is used for performing an Application (APP) URL check and DNS resolution with cloud-delivered security services (CDSS) (e.g., providing a verdict of pass or fail).

At stage 118, the IP address is passed and a tenant verdict is determined using the assigned to a respective Enterprise tenant's security processing node (SPN) (e.g., FWaaS) for the security processing using the respective tenant LB in the SASE cloud-based environment as shown at 148. In this example implementation, once the 5G data plane traffic is received on the SPI/interconnect, the flow is assigned to an Enterprise tenant's SPN (e.g., performing deep packet inspection (DPI) of the data plane traffic, such as to provide layer-7 security processing) for automatically detecting an IP authorized (auth) list allow/deny, and for a flow in the allow list, verifying the URL category and DNS security are automatically performed as a first level verdict.

In some embodiments, the 5G SPN entities/clusters (e.g., firewall as a service (FWaaS)) are configured to provide the following DPI capabilities: DPI of Packet Forwarding Control Protocol (PFCP) traffic (e.g., and/or other protocol formatted network traffic) received via, for example, a security I/C router from the Interconnect 138. In an example implementation, the firewall as a service entities are configured to provide DPI capabilities (e.g., including to identify a UE IP, IMSI/SUPI, IMEI/PEI, S-NSSAI, APN/DNN, and/or RAT Type information, application (App) ID, etc.) of, for example, PFCP messages that pass through, for example, the N6 and/or other interfaces between UPF and other 5G core mobile network entities within the core mobile network environment to apply context-based security traffic based on a policy (e.g., layer-7 security and/or other security policy enforcement).

In one embodiment, the disclosed 5G SASE techniques rely on the 5G packet core mobile network for interpreting the PFCP messages and sending the summarized information (e.g., including various associated contextual information as described herein) via a communication mechanism (e.g., RADIUS accounting messages, DIAMETER messages, and/or another protocol can be similarly used, and/or an API communication mechanism can be similarly used) to the 5G SASE solution.

In another embodiment, the security platform is configured to utilize DPI to extract various contextual information from monitored 5G packet core mobile network protocols, which can include, for example, removing the entry of a UE IP and related contextual information from the database if either of the following messages occur based on the monitoring of the PFCP protocol: (1) a PFCP session deletion request/response message to delete the PFCP control session; and (2) user/subscriber session(s) timeout message (e.g., such timeouts can be configurable). More specifically, in this example implementation in which the security platform is configured to utilize DPI to extract various contextual information from monitored 5G packet core mobile network protocols, the firewall as a service entities provided via 5G SPN clusters 114 are configured to monitor PFCP messages including the following: (1) a PFCP Session Establishment Procedure (e.g., as per 3GPP T.S 29.244 v 18.3.0 (e.g., which is publicly available at https://portal.3gpp.org/desktopmodules/Specifications/SpecificationDetails.aspx?specificationId=3111), a PFCP Session Establishment procedure shall be used to set up a PFCP session between a CP function and a UP function and configure Rules in the UP function so that the UP function can handle incoming packets); (2) a PFCP Session Modification Procedure (e.g., the PFCP Session Modification procedure shall be used to modify an existing PFCP session, e.g., to configure a new rule, to modify an existing rule, to delete an existing rule); and (3) a PFCP Session Deletion Procedure (e.g., the PFCP Session Deletion procedure shall be used to delete an existing PFCP session between the CP function and the UP function) to facilitate extraction of the above-described contextual information.

In this example implementation, the firewall as a service entities provided via 5G SPN entities/clusters are configured to provide various enhanced, context-based security based on the monitored user plane data traffic flows received via the Interconnect at the mapped firewall as a service entity/ies (e.g., to set up the flow information for each new UE connection to the 5G core mobile network). The data traffic flows (e.g., sessions) can be correlated based on the source IP address for the data traffic flows the relevant UE IP received and stored above to associate such data traffic flows to the relevant context information associated with the UE IP. The firewall as a service entity/ies can then select and apply a security policy to each data traffic flow using the relevant contextual information for each such data traffic flow.

As such, the disclosed techniques for providing SASE for mobile networks facilitate a cloud native SASE stack with SIM-based authentication, federation, and interconnect with core mobile networks (e.g., a 4G/5G/6G/later mobile network core environment).

In this example implementation, the firewall as a service entities provided via 5G SPN entities/clusters are configured to provide various SASE related services, including for example Artificial Intelligence powered Operations (AIOps), Software as a Service (SaaS) secure and high-speed connections (e.g., for SalesForce, Microsoft Office 365, and/or other SaaS solutions), Data Loss Prevention (DLP) security, IoT security, Domain Name System (DNS) security, Advanced Threat Protection (ATP) security, Advanced Uniform Resource Link (URL) security, and/or other SASE/security related services.

In addition, the firewall as a service entities provided via 5G SPN entities/clusters can also be in network communication with a Cloud Security Service (not shown) (e.g., a commercially available cloud-based security service, such as the WildFire™ (ADV WF) cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, a Cloud Security Service can be utilized to provide the security platforms with dynamic prevention signatures for malware, DNS, URLs, CNC malware, and/or other malware as well as to receive malware samples for further security analysis.

At stage 120, the assigned Enterprise tenant's SPN receives the data plane traffic for security processing, automatically applies a relevant security policy (e.g., the security policy can be defined per enterprise tenant), and then sends the traffic, if allowed, based on the SPN processing using the security policy, to the remote endpoint (EP), such as egressing traffic to an Internet access, a Software as a Service (SaaS) app, and/or a private application (app) (e.g., a private Enterprise app, etc.). If the policy determines that the traffic is not allowed based on the SPN processing using the security policy, then the traffic can be blocked, dropped, and/or another action can similarly be performed based on the policy (e.g., quarantining, logging, etc.). As such, per tenant level security policies can be configured using the cloud-based SASE environment.

As such, the disclosed techniques provide a solution for providing explicit proxy solutions for 5G SASE with service provider network attach, which is more secure with direct connection and low latency. The disclosed techniques also remove the attack surface on Internet routing transport. Further, the disclosed techniques facilitate applying security policy inline with the Explicit proxy solution by providing a first level layer security with Envoy/proxy layer (144) and deep packet inspection (DPI) with the SPNs (148).

Moreover, the disclosed techniques provide a scalable solution for providing explicit proxy solutions for 5G SASE with service provider network attach. For example, an Enterprise that is already an Explicit proxy SASE customer can use the same stack that is executing in the SASE cloud-based environment (148).

Additional example use cases for the disclosed techniques for providing explicit proxy solutions for 5G SASE with service provider network attach will be further described below.

### Example Use Cases for Explicit Proxy Solutions for 5G Sase With Service Provider Network Attach

As a first example use case, the disclosed SASE solution can be provided for all network fabric (e.g., private 5G, micro 5G, IoT, micro 4G, etc.) with a zero trust policy based on any network identity (e.g., IMSI, IMEI, System Identification Number (SID), Serial Number (SN), APN, etc.).

As a second example use case, the disclosed SASE solution facilitates a multi-tenant platform that supports a security service to handle multiple enterprises and manage respective security policies for each individual enterprise.

As a third example use case, the disclosed SASE solution provides for an extendable SASE platform for unlicensed spectrum manage solutions, such as Citizens Broadband Radio Service (CBRS) 4G/5G.

As a fourth example use case, the disclosed SASE solution facilitates a unified SASE solution for managing any enterprise fabric transport traffic, including, for example, private 5G, Wi-Fi, IoT/IIoT, and proxy traffic.

As a fifth example use case, the disclosed SASE solution facilitates a unified SASE platform for per enterprise, per device, and per network level traffic management separation and policy management.

Accordingly, the above-described techniques and various embodiments for providing explicit proxy solutions for 5G SASE with service provider network attach can be applied to provide one or more of the following: (1) secure data traffic flow (e.g., private app access, SaaS app access, other apps/services, etc.) from and to 4G/5G/6G/later devices; (2) secure Internet access from 4G/5G/6G/later UEs; (3) secure access to enterprise data center from 4G/5G/6G/later UEs; (4) enforcement of UE (user) specific security policies (e.g., based on UE

IP, IMSI, IMEI, location, APN/DNN, network slice, RAT, and/or other contextual information); and (5) separation of security policies for each tenant (e.g., automatically detecting each MSP Enterprise tenant (tenant ID) associated with each data packet passing through the SASE/security core network).

Additional example processes for the disclosed techniques for providing explicit proxy solutions for 5G SASE with service provider network attach will be further described below.

### Example Process Embodiments for Explicit Proxy Solutions for 5G Sase With Service Provider Network Attach

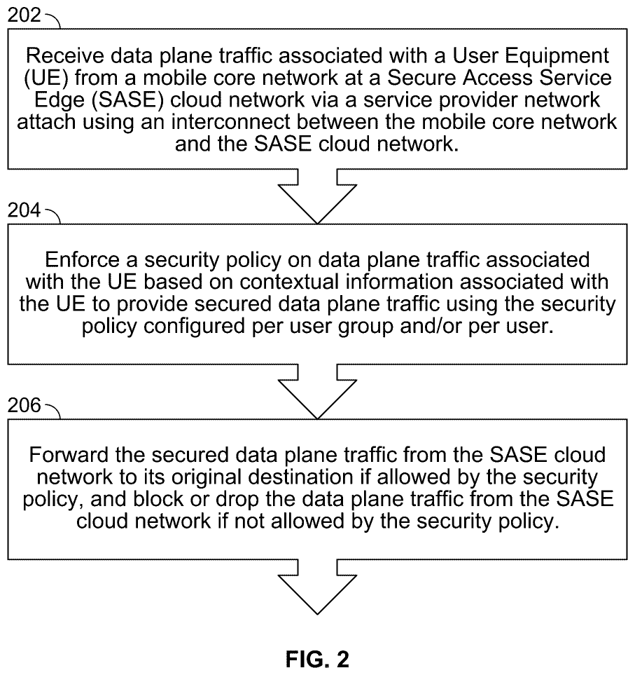

FIG. 2 is a flow diagram of a process for providing explicit proxy solutions for 5G SASE with service provider network attach in accordance with some embodiments. In some embodiments, a process as shown in FIG. 2 is performed by the SASE solution and techniques as similarly described above including the embodiments described above with respect to FIG. 1. In one embodiment, the process shown in FIG. 2 is performed, at least in part, by 5G SPN entities/clusters as described above with respect to FIG. 1.

The process begins at 202. At 202, data plane traffic associated with a User Equipment (UE) from a mobile core network is received at a Secure Access Service Edge (SASE) cloud network using an interconnect between the mobile core network and the SASE cloud network. As similarly described above with respect to FIG. 1, an interconnect (e.g., a GCP interconnect or other cloud to cloud interconnect) can be used for securely transmitting traffic from the mobile core network to the SASE cloud network.

At 204, enforcing a security policy on data plane traffic associated with the UE based on contextual information associated with the UE to provide secured data plane traffic using the security policy configured per user group and/or per user is performed. For example, various enforcement actions (e.g., allow/pass, block/drop, alert, tag, monitor, log, throttle, restrict access, and/or other enforcement actions) can be performed using the security platform as similarly described above. As similarly described above with respect to FIG. 1, the security policy can be determined and/or enforced based on various combinations of UE IP, location, hardware identifier, subscriber identity, and RAT information and/or based on information detected/determined using DPI-based firewall techniques, such as by performing URL filtering, identifying an Application-ID, identifying a Content-ID, and/or using other DPI-based firewall techniques as similarly described above.

At 206, forwarding the secured data plane traffic from the SASE cloud network to its original destination if allowed by the security policy, and blocking or dropping the data plane traffic from the SASE cloud network if not allowed by the security policy, is performed. In this example implementation, the secured data plane traffic egresses the mobile core network to its original destination.

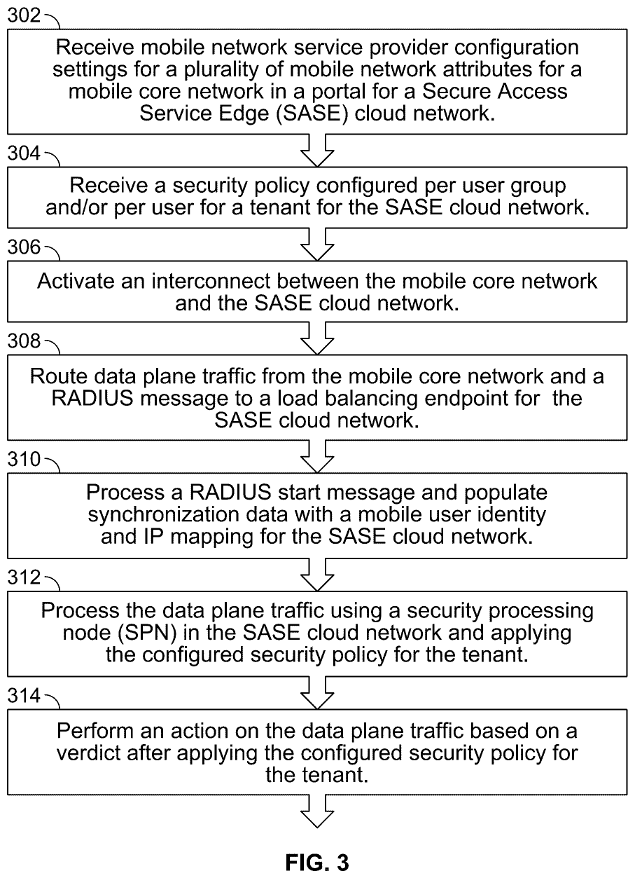

FIG. 3 is another flow diagram of a process for providing explicit proxy solutions for 5G SASE with service provider network attach in accordance with some embodiments. In some embodiments, a process as shown in FIG. 3 is performed by the SASE solution and techniques as similarly described above including the embodiments described above with respect to FIG. 1. In one embodiment, the process shown in FIG. 3 is performed, at least in part, by 5G SPN entities/clusters as described above with respect to FIG. 1.

At 302, mobile network service provider configuration settings for a plurality of mobile network attributes for a mobile core network are received in a portal for a Secure Access Service Edge (SASE) cloud network.

At 304, a security policy configured per user group and/or per user for a tenant for the SASE cloud network is received (e.g., in the portal).

At 306, an interconnect is activated between the mobile core network and the SASE cloud network.

At 308, data plane traffic is routed from the mobile core network and a RADIUS message to a load balancing endpoint for the SASE cloud network.

At 310, a RADIUS start message is processed to populate synchronization data with a mobile user identity and IP mapping for the SASE cloud network.

At 312, the data plane traffic is processed using a security processing node (SPN) in the SASE cloud network and applying the configured security policy for the tenant.

At 314, an action is performed on the data plane traffic based on a verdict after applying the configured security policy for the tenant.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive traffic associated with a User Equipment (UE) from a mobile core network at a Secure Access Service Edge (SASE) cloud network via a service provider network attach using an interconnect between the mobile core network and the SASE cloud network;
enforce a security policy on data plane traffic associated with the UE based on contextual information associated with the UE to provide secured data plane traffic using the security policy configured per user group and/or per user; and
forward the secured data plane traffic from the SASE cloud network to its original destination if allowed by the security policy, and block or drop the data plane traffic from the SASE cloud network if not allowed by the security policy; and
a memory coupled to the processor and configured to provide the processor with instructions.

2. The system recited in claim 1, wherein the SASE cloud network includes a firewall as a service that is configured with a plurality of security policies based on a subscriber identity and an application identifier, and wherein the subscriber identity includes an International Mobile Subscriber Identity (IMSI).

3. The system recited in claim 1, wherein the SASE cloud network includes a firewall as a service that is configured with a plurality of security policies based on a subscriber identity, a unique device identifier, and an application identifier, wherein the subscriber identity includes an International Mobile Subscriber Identity (IMSI), and wherein the unique device identifier includes an International Mobile Equipment Identifier (IMEI).

4. The system recited in claim 1, wherein the mobile core network includes a 4G mobile core network, a 5G mobile core network, and/or 6G mobile core network.

5. The system recited in claim 1, wherein the data plane traffic is secured from and to 4G, 5G, and/or 6G UE devices.

6. The system recited in claim 1, wherein Internet access is secured from and to 4G, 5G, and/or 6G UE devices.

7. The system recited in claim 1, wherein enterprise data center access is secured from and to 4G, 5G, and/or 6G UE devices.

8. The system recited in claim 1, wherein selection and the enforcement of the security policy is based on the contextual information associated with the UE and the data plane traffic correlated with the UE based on a UE Internet Protocol (IP) address.

9. The system recited in claim 1, wherein a firewall as a service (FWaaS) associated with the SASE is configured to perform Uniform Resource Link (URL) filtering for the data plane traffic.

10. The system recited in claim 1, wherein a firewall as a service (FWaaS) associated with the SASE is configured to perform application Denial of Service (DoS) detection for the data plane traffic.

11. The system recited in claim 1, wherein a firewall as a service (FWaaS) associated with the SASE is configured to perform application Denial of Service (DoS) prevention for the data plane traffic.

12. The system recited in claim 1, wherein each of a plurality of security policies is distinctly selected and enforced for each mobile service provider (MSP) enterprise tenant at the SASE cloud network, wherein per tenant security policy configuration and enforcement are provided by the SASE cloud network.

13. The system recited in claim 1, wherein the data plane traffic is encapsulated with meta information, including a subscriber identity and/or a unique device identifier.

14. The system recited in claim 1, wherein the processor is further configured to:
determine the security policy to apply at the SASE cloud network to the data plane traffic based on a subscriber identity and/or a unique device identifier.

15. A method, comprising:
receiving traffic associated with a User Equipment (UE) from a mobile core network at a Secure Access Service Edge (SASE) cloud network via a service provider network attach using an interconnect between the mobile core network and the SASE cloud network;
enforcing a security policy on data plane traffic associated with the UE based on contextual information associated with the UE to provide secured data plane traffic using the security policy configured per user group and/or per user; and
forwarding the secured data plane traffic from the SASE cloud network to its original destination if allowed by the security policy, and block or drop the data plane traffic from the SASE cloud network if not allowed by the security policy.

16. The method of claim 15, wherein the SASE cloud network includes a firewall as a service that is configured with a plurality of security policies based on a subscriber identity and an application identifier, and wherein the subscriber identity includes an International Mobile Subscriber Identity (IMSI).

17. The method of claim 15, wherein the SASE cloud network includes a firewall as a service that is configured with a plurality of security policies based on a subscriber identity, a unique device identifier, and an application identifier, wherein the subscriber identity includes an International Mobile Subscriber Identity (IMSI), and wherein the unique device identifier includes an International Mobile Equipment Identifier (IMEI).

18. A computer program product, the computer program product being embodied in a tangible computer readable storage medium and comprising computer instructions for:
receiving traffic associated with a User Equipment (UE) from a mobile core network at a Secure Access Service Edge (SASE) cloud network via a service provider network attach using an interconnect between the mobile core network and the SASE cloud network;
enforcing a security policy on data plane traffic associated with the UE based on contextual information associated with the UE to provide secured data plane traffic using the security policy configured per user group and/or per user; and
forwarding the secured data plane traffic from the SASE cloud network to its original destination if allowed by the security policy, and block or drop the data plane traffic from the SASE cloud network if not allowed by the security policy.

19. The computer program product recited in claim 18, wherein the SASE cloud network includes a firewall as a service that is configured with a plurality of security policies based on a subscriber identity and an application identifier, and wherein the subscriber identity includes an International Mobile Subscriber Identity (IMSI).

20. The computer program product recited in claim 18, wherein the SASE cloud network includes a firewall as a service that is configured with a plurality of security policies based on a subscriber identity, a unique device identifier, and an application identifier, wherein the subscriber identity includes an International Mobile Subscriber Identity (IMSI), and wherein the unique device identifier includes an International Mobile Equipment Identifier (IMEI).

21. A system, comprising:
a processor configured to:
receive mobile network service provider configuration settings for a plurality of mobile network attributes for a mobile core network in a portal for a Secure Access Service Edge (SASE) cloud network;
receive a security policy configured per user group and/or per user for a tenant for the SASE cloud network;
activate an interconnect between the mobile core network and the SASE cloud network;
route data plane traffic from the mobile core network and a RADIUS message to a load balancing endpoint for the SASE cloud network;
process a RADIUS start message and populate synchronization data with a mobile user identity and IP mapping for the SASE cloud network;
process the data plane traffic using a security processing node (SPN) in the SASE cloud network and applying the configured security policy for the tenant; and
perform an action on the data plane traffic based on a verdict after applying the configured security policy for the tenant; and
a memory coupled to the processor and configured to provide the processor with instructions.
